(19) United States
(12) Patent Application Publication
(10) Pub. No.: US 2007/0231447 A1
(43) Pub. Date: Oct. 4, 2007

(54) STEROL COMPOSITIONS AND METHODS OF MAKING SAME

(75) Inventors: Michael J. Fleckenstein, Decatur, IL (US); Thomas V. Gottemoller, Mt. Zion, IL (US); Stephen J. O'Brien, Decatur, IL (US)

Correspondence Address: KIRKPATRICK & LOCKHART PRESTON GATES ELLIS LLP;HENRY W. OLIVER BUILDING, 535 SMITHFIELD STREET, PITTSBURGH, PA, 15222, US

(73) Assignee: Archer-Daniels-Midland Company, Decatur, IL (US)

(21) Appl. No.: 11/693,222

(22) Filed: Mar. 29, 2007

Related U.S. Application Data
(60) Provisional application No. 60/788,906, filed on Apr. 4, 2006.

(51) Int. Cl. A23D 9/00

(52) U.S. Cl. 426/611

(57) ABSTRACT

The present invention provides compositions of sterol and monoglyceride, methods of making such compositions, and methods of making food products containing the compositions, such as beverages.

### CROSS REFERENCE TO RELATED APPLICATIONS

This application claims priority under 35 U.S.C. §119(e) to U.S. Provisional Application Ser. No. 60/788,906, filed Apr. 4, 2006, the disclosure of which is incorporated in its entirety by reference herein.

### TECHNICAL FIELD

The invention pertains to a method of making a composition of sterols and monoglycerides. The invention also pertains to food products, such as beverages, containing the composition. The combination of free sterols and monoglycerides provides a product which is easier to use and more dense in free sterols than sterols that have been chemically processed,

### BACKGROUND

More than 750,000 people in the United States die from coronary heart disease and strokes every year. About 1.25 million people suffer from heart attacks every year, half of which occur without warning. Coronary heart disease is the most common cause of death among men and women in the United States. Despite a century of drug development, presently ten times as many Americans die of heart attacks as at the turn of the century,

According to the American Heart Association, serum cholesterol levels are a major predictor of cardiovascular disease. Cholesterol, a soft, waxy substance found among the lipids in the blood stream, is important to proper body function because it is used to form cell membranes, some hormones and other necessary bodily tissues. However, a high level of cholesterol in the blood (hypercholesterolemia) is a major risk factor for coronary heart disease, and has been linked to heart attack.

Cholesterol has been known for many years to be a component of atherosclerotic plaques. Mounting evidence supports the finding that diets high in cholesterol may increase the levels of cholesterol in the blood which, in turn, increase the risk of atherosclerotic disease and its attendant manifestations of heart attack, stroke and other tissue injuries resulting from atherosclerosis. Cholesterol absorbed from dietary sources is thought to increase the risk of atherosclerotic disease.

Various compounds have been reported to reduce cholesterol levels in humans. For example, sterols, particularly beta-sitosterol, have been reported to have anticholesterolemic effects, and are believed to inhibit cholesterol absorption in the small intestine. Plant sterols are structurally similar to cholesterol and are thought to reduce cholesterol absorption and serum cholesterol levels, while not being absorbed in the intestinal tract. Phytosterols are therefore useful in treating individuals with mildly increased serum cholesterol, and are included in food products and dietary supplements sold to the general population. However, sterols that are added to beverages do not mix well, and tend to separate and float on the surface of the liquid.

There is, therefore, a need for products containing sterols which can be used by consumers as part of an overall strategy against cardiovascular disease, which are safe enough to be taken without direct medical supervision, and can be added to liquids and beverages.

### SUMMARY

Sterol-monoglyceride compositions are provided, and methods for making such compositions. Food products containing the compositions, such as beverages, are also provided.

In one embodiment, provided herein is a method of making a powdered co-crystallized sterol-monoglyceride mixture. The methods includes combining and melting the monoglyceride and sterol to form a melted monoglyceride-sterol mixture, and subjecting the mixture to conditions of high shear while cooling the mixture to about 70° C. or below, which causes the mixture to co-crystallize into a solid. The resulting crystallized product can be ground to produce a free-flowing powder.

In any of the embodiments described herein, the sterol can be about 50% to about 90% by weight of the sterol-monoglyceride mixture. The sterol can make up 80% by weight of the mixture. The sterol can have a melting point over about 120° C., for instance, of between about 140° C. and about 145° C. The monoglyceride can have a melting point over about 25° C., for instance, of between about 30° C. and about 95° C. The preferred monoglycerides have a melting point between 25° C and 50° C.

Also provided herein is a method of making a beverage or a dry beverage mix containing added sterols, where the method includes combining and melting the monoglyceride and sterol to form a melted monoglyceride-sterol mixture, and subjecting the mixture to conditions of high shear while cooling the mixture to about 70° C. or below, which causes the mixture to crystallize. The resulting crystallized product is added to a beverage or a dry beverage mix. The beverage can be pasteurized or homogenized.

In any of the food products described herein, the co-crystallized sterol-monoglyceride composition can be added in an amount sufficient to provide between about 0.4 grams to about 1.5 grams of sterols per serving of the food product.

The food product can be a beverage or a dry beverage mix, and can be a juice, a sports drink, or milk.

It should be understood that this invention is not limited to the embodiments disclosed in this Summary, and it is intended to cover modifications that are within the spirit and scope of the invention, as defined by the claims.

### DETAILED DESCRIPTION

Other than in the examples herein, or unless otherwise expressly specified, all of the numerical ranges, amounts, values and percentages, such as those for amounts of materials, elemental contents, times and temperatures of reaction, ratios of amounts, and others, in the following portion of the specification and attached claims may be read as if prefaced by the word “about” even though the term “about” may not expressly appear with the value, amount, or range. Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains error necessarily resulting from the standard deviation found in its underlying respective testing measurements. Furthermore, when numerical ranges are set forth herein, these ranges are inclusive of the recited range end points (i.e., end points may be used). When percentages by weight are used herein, the numerical values reported are relative to the total weight.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10. The terms “one,” “a,” or “an” as used herein are intended to include “at least one” or “one or more,” unless otherwise indicated.

Any patent, publication, or other disclosure material, in whole or in part, that is said to be incorporated by reference herein is incorporated herein only to the extent that the incorporated material does not conflict with existing definitions, statements, or other disclosure material set forth in this disclosure. As such, and to the extent necessary, the disclosure as set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

The present disclosure describes several different features and aspects of the invention with reference to various exemplary non-limiting embodiments. It is understood, however, that the invention embraces numerous alternative embodiments, which may be accomplished by combining any of the different features, aspects, and embodiments described herein in any combination that one of ordinary skill in the art would find useful.

The present invention includes compositions of sterol and monoglyceride, food products containing such compositions, such as beverages, and methods of making such compositions and food products. Such food products may help to maintain or reduce the consumer's serum cholesterol level.

In general, the methods of making the crystallized composition include combining and melting monoglyceride and sterol to form a mixture, and subjecting the mixture to conditions of high shear and cooling. In some embodiments, the mixture is subjected to high shear while cooling. This causes the sterol and the monoglyceride to co-crystallize into a dry composition. The crystallized mixture can be used as is, or can be ground to produce a free-flowing powder. As used herein, the term “dry” is meant to include compositions that are free or substantially free of moisture, and includes those compositions that have a moisture content of less than 1%, by weight.

Cholesterol generally comes from two sources. Endogenic cholesterol is produced in the body, mostly in the liver (approximately 1,000 milligrams a day). Dietary cholesterol is found in foods that come from animals, such as meat, poultry, fish, seafood and dairy products. In contrast, foods from plants (fruits, vegetables, grains, nuts and seeds) do not contain cholesterol. When ingested, dietary cholesterol increases the cholesterol level in blood and may act as a main cause of cardiovascular diseases, including hyperlipidemia, arteriosclerosis, arrhythmia, cardiac infarction, and the like. Both endogenic and dietary cholesterol pass through the small intestine, where about half is absorbed into the bloodstream. This level of absorption may be reduced through the practice of the present invention.

Cholesterol is insoluble in the blood, and must be transported to and from the cells by lipoproteins. There are several kinds of lipoproteins, the most important of which are low-density lipoprotein (LDL) and high-density lipoprotein (HDL).

Low-density lipoprotein is the major cholesterol carrier in the blood. Excess LDL cholesterol circulating in the blood can slowly build up within the walls of the arteries feeding the heart and brain. Together with other substances it can form plaque, a thick, hard deposit that can clog the arteries, a condition known as atherosclerosis. The formation of a clot (or thrombus) in the region of this plaque can block the flow of blood to part of the heart muscle and cause a heart attack. If a clot blocks the flow of blood to part of the brain, the result is a stroke. A high level of LDL cholesterol reflects an increased risk of heart disease. Thus, LDL cholesterol is sometimes referred to as “bad cholesterol.”

High density lipoprotein (“HDL”) carries about one-third to one-fourth of blood cholesterol. It is believed that HDL carries cholesterol away from the arteries and back to the liver, from which it is ultimately passed from the body. Some experts believe HDL removes excess cholesterol from atherosclerotic plaques and, thus, slows their growth. HDL is known as “good cholesterol” because a high level of HDL appears to protect against heart attack. The opposite may also be true: a low HDL level indicates a greater risk of a heart attack. Thus, the risk of having a heart attack or stroke may be strongly predicted by the amounts of low-density lipoprotein (LDL), high-density lipoprotein (HDL), and triglycerides in the blood.

Serum cholesterol and triglyceride levels can be reduced through medical intervention. Compounds that have been studied in connection with the treatment and prevention of diseases including arteriosclerosis and high cholesterol levels include statins. Statins block HMGCoA reductase.

However, statins also sometimes cause liver dysfunction, or other undesirable effects such as myopathy. In addition, some patients taking statins may respond to the decreased rate of cholesterol synthesis by a compensatory increase in the rate at which dietary cholesterol is absorbed from food. A recent study reports that 80% of patients taking statins as a monotherapy failed to reach treatment goals. Increasing statin dosages to the levels required to overcome this compensatory increase in cholesterol absorption frequently produces an 11-fold increase in the incidence of liver complications. Because of this risk of liver complications, statins must be taken under a doctor's supervision.

In some patients, cholesterol and triglyceride levels also can be reduced through dietary modification, such as reduction of the dietary intake of cholesterol and saturated fats. However, in many cases high serum cholesterol cannot be reduced by lowering dietary cholesterol and in some, dietary modifications have given rise to new problems. For example, in recent years the substitution of margarine for butter has been promoted because butter is high in cholesterol and saturated fats, while stick margarine has a semi-solid consistency based on the presence of hydrogenated oils. The hydrogenation process, however, forms trans fats, which clinical studies have demonstrated are atherogenic, causing two to three times the cardiovascular risk relative to the naturally saturated fats which give butter its stability. The health advantage of margarine when compared to butter is now suspect, as margarine, particularly stick margarine, may contain 20% to 30% of trans fats. Presently, the American Heart Association recommends the use of commercially available soft margarine, or trans-free margarine, which is formulated from either completely hydrogenated palm oil or palm oil fractions. This form of margarine, while free of trans fats, contains increased levels of saturated fats, the second most dangerous component of margarine.

Other compounds have been reported to reduce cholesterol levels in humans. For instance, high cholesterol levels in serum may be lowered effectively by altering the intestinal metabolism of lipids. Certain plant sterols and plant stanols, such as beta-sitosterol (24-ethyl-5-cholestene-3-beta-ol) and its hydrogenated form (beta-sitostanol (24-ethyl-5-alpha-cholestane-3-beta-ol) have been reported to have anticholesterolemic effects, and are believed to inhibit cholesterol absorption in the small intestine. A commercially available margarine first introduced in Finland, Benecol®, a registered trademark of Raiso Benecol Oy Corporation, contains hydrogenated plant sterols extracted from pulp and paper waste. It has been said to achieve a 10-15% reduction in cholesterol levels in patients substituting Benecol® margarine for standard margarine in their diets. This reduction corresponds to a twenty to thirty percent decrease in cardiovascular risk.

Sterols are a subtype of steroids, and include cholesterol, phytosterols, and some steroid hormones. The structural differences between a cholesterol molecule and a sterol molecule are primarily found in the structure of the side chain of the basic frame. Sterols contain a hydroxy group at the C3 position and a branched aliphatic chain of 8-10 carbon atoms at the C17 position (Baileys Industrial Oil & Fat Products: General Applications, Vol. 1, pp. 402-403, John Wiley & Sons, Inc., New York, N.Y. (1996), incorporated in it's entirety by reference herein).

Phytosterols or plant sterols refer to the sterols occurring in the plant kingdom which closely resemble cholesterol in terms of structure. They are, like cholesterol in mammals, a structural component of external and internal membranes and are, thus, essential constituents for the living functions of cells. Plant sterols exist naturally in saturated and unsaturated forms, as free alcohols and as esters. The unsaturated forms dominate.

Plant sterols may be hydrogenated to produce plant stanols, i.e., phytostanols. Stanols are completely saturated forms of sterols and lack the carbon-carbon double bonds found in sterols. In plants, sterols are more abundant than stanols, and beta-sitosterol, stigmasterol, and campesterol, are, generally, the most abundant.

It has been reported that stanols are more effective per unit weight than sterols in blocking cholesterol absorption, and that stanols are not absorbed. Both sterols and stanols have been used as relative markers of cholesterol absorption because of their unabsorbability.

Plant sterols are natural components of vegetable fats and oils, and their use in food products is considered safe. Plant sterols are not absorbed from the intestine, or only absorbed in very small amounts. There are a variety of naturally occurring plant sterols which have been reported to have a cholesterol-reducing effect, although not all have equivalent action.

Plant sterols are thought to displace cholesterol in bile salt micelles. Approximately half of the dietary cholesterol ingested is absorbed whereas less than 5% of beta-sitosterol is absorbed. When the plant sterols displace cholesterol of the bile salt micelles, the cholesterol is fecally excreted.

Phytosterols have been reported to lower LDL cholesterol levels with little or no effect on high-density lipoprotein (HDL) cholesterol or triglyceride levels, and the effect appears to be consistent across different types of diets. A number of products are now commercially available which contain phytosterols, either added to the product or used as a replacement fat. Many of these products are described in various publications.

Solubility of free plant sterols and stanols is limited in oils and/or fats, which reduces the usefulness of the free sterols and stanols in cholesterol-reducing food products. To increase solubility, the sterols and stanols may be esterified with fatty acids. Steryl esters are compounds that contain a fatty acid linked to the C3 carbon of a phytosterol via an ester bond.

Phytosterols are found in various plant oils including tall oils (from pine trees) and oliseeds such as corn, canola, soy, safflower, sunflower, rapeseed, cottonseed, peanut and cocoa. In oilseeds, the most abundant phytosterols are sitosterol (about 52 to 89% of total sterols), campesterol (about 2 to 30% of total sterols), and stigmasterol (up to 26% of total sterols). Most of the sterols found in cacao are in the cocoa butter, at levels of about 200 ppm (about 200 mg/Kg), and a 40 g chocolate bar typically contains approximately 1.6 mg of naturally-occurring plant sterls.

In some embodiments of the present invention, the mixture may contain between 50% and 90% sterol by weight. The melted monoglyceride and sterol can be fed into an extruder and subjected to high shear and cooled. The screw or screws in the extruder provide the shear. The extruder may be cold-jacketed to cool the mixture to 70° C or below.

The sterols can be sterols derived from various sources, such as, but not limited to, vegetable sources (such as, but not limited to, CardioAid™, from Archer Daniels Midland, Decatur, Ill., USA). The sterls can be derived from wood (such as, but limited to, CardioAid-WD™, from Archer Daniels Midland, Decatur, Ill., USA).

Any phytosterol compound can be used in the present invention. By “phytosterol” is meant the various phytosterols and their hydrogenated stanols, and also the esters of the phytosterols and their hydrogenated stanols. Such phytosterols include, but are not limited to, avenasterol, avenastanol, D5-avenasterol, D5-avenastanol, D7-avenasterol and D7-avenastanol, and their esters; brassicasterol and brassicastanol, and their esters; campesterol and campestanol, and their esters (such as, but not limited to, campesterol laurate ester, campestanol laurate ester, campesterol linoleate ester, campestanol linoleate ester, campesterol myristearate ester, campestanol myristearate ester, campesterol oleate ester, campestanol oleate ester, campesterol ricinoleate ester, campestanol ricinoleate ester, campesterol stearate ester, and campestanol stearate ester); sitosterol, sitostanol, alpha-sitosterol, alpha-sitostanol, beta-sitosterol, beta-sitostanol, gamma-sitosterol and gamma-sitostanol, and their esters (such as, but not limited to, alpha-sitosterol laurate ester, alpha-sitostanol laurate ester, alpha-sitosterol myristearate ester, alpha-sitostanol myristearate ester, alpha-sitosterol oleate ester, alpha-sitostanol oleate ester, alpha-sitosterol stearate ester, alpha-sitostanol stearate ester, beta-sitosterol laurate ester, beta-sitostanol laurate ester, beta-sitosterol linoleate ester, beta-sitostanol linoleate ester, beta-sitosterol myristearate ester, beta-sitlostanol myristearate ester, beta-sitosterol oleate ester, beta-sitostanol oleate ester, beta-sitosterol palmitate ester, beta-sitostanol palmitate ester, beta-sitosterol ricinoleate ester, beta-sitostanol ricinoleate ester, gamma-sitosterol laurate ester, gamma-sitostanol laurate ester, gamma-sitosterol oleate ester, gamma-sitostanol oleate ester, gamma-sitosterol palmitate ester, gamma-sitostanol palmitate ester, gamma-sitosterol stearate ester and gamma-sitostanol stearate ester); stigmasterol, stigmastanol, D7-stigmasterol and D7-stigmastanol, and their esters (such as, but not limited to, stigmasterol caprate ester, stigmastanol caprate ester stigmasterol laurate ester, stigmastanol laurate ester, stigmasterol linoleate ester, stigmastanol linoleate ester, stigmasterol oleate ester, stigmastanol oleate ester, stigmasterol ricinoleate ester, stigmastanol ricinoleate ester, stigmasterol stearate ester and stigmastanol stearate ester). The term “phytosterols” also includes mixtures of any of the above.

Steryl esters contain about 65% free sterols, and therefore the inclusion rates of steryl esters should be increased so as to provide equivalent levels of free sterols.

The term “monoglyceride,” as used herein, is intended to include compositions having a major portion of monoglycerides, and may contain at least 40% by weight and, in some embodiments, may contain 90% or more monoglyceride by weight. Also, the monoglyceride compositions may include some diglyceride, and in some embodiments may contain no more than 60% by weight diglyceride and in other embodiments may contain no more than 10% by weight diglyceride. The glyceride compositions may also include some triglycerides, and in some embodiments may contain no more than 10% by weight triglyceride. Monoglycerides with an iodine value (IV) of between about 1 and about 100 can be used. Mixtures of mono-diglycerides also can be used, but should have an alpha mono content of greater than about 35%.

The monoglycerides used in this invention may be conventional monoglycerides long used in the baking industry. In accordance with prior terminology in the art, the term “monoglyceride” includes monoesters of glycerine as well as mixed monoesters and diesters of glycerine. Typical monoglyceride compositions suitable for use in accordance with the present invention are, for example, a mixture of monoglycerides and diglycerides (ca. 55% alpha mono) formed from fatty acids from a blend of cottonseed oil and fully hydrogenated cottonseed oil, having an iodine value of about 71, a mixture of monoglycerides and diglycerides (ca. 56% alpha mono) formed from fatty acids from a blend of lard and tallow having an iodine value of about 47 and a mixture of monoglycerides and diglycerides (ca. 56% alpha mono) formed from fatty acids from partially hydrogenated tallow having an iodine value of about 35.

The fatty acid monoglycerides suitable for use in accordance with this invention may be prepared by conventional methods of glycerolysis of edible fats and oils, e.g., by reacting glycerine with a fatty acid glyceride or e.g., by reacting glycerine with a fatty acid glyceride or other fatty acid ester, or by directly esterifying glycerine with a fatty acid having from 12 to 22 carbon atoms. Examples of the fatty acid monoglycerides which may be used as the monoglyceride constituent of the present invention are glycerol monostearate, glycerol monooleate and glycerol monopalmitate. Glycerolysis reaction products, i.e., the mono and diglyceride mixtures which are the result of glycerolysis containing usually about 40-65% of the monoester fraction, may also be used. One monoglyceride is a fully hydrogenated, high-purity monoglyceride obtained from soybean oil. That monoglyceride has about 95% monoester (about 90% alpha ester and about 5% beta-ester).

In addition to the monoglycerides above, the term monoglyceride includes the heretofore defined monoglycerides which have been esterified (primarily at the beta position) with one additional organic acid, such as lactic acid, succinic acid or maleic acid.

The sterol and the monoglyceride may be melted and combined under conditions of high shear. The sterol and monoglyceride can be heated so that they are fluid, by which is meant that they are flowable or pumpable. For the purposes of the present invention the term “fluid” may be, but is not necessarily, synonymous with liquid. Oleaginous fluids are normally considered to have both liquid and solid phases, the latter being in the form of solid particles of fat in suspension. The term liquid implies no solid phase.

The sterol and the monoglyceride can be heated up to a temperature sufficient to melt the sterol and the monoglyceride, e.g., up to about 110° C., or as high as about 120° C.

Once the sterol and monoglyceride are melted, they may be fed into an extruder. Alternatively, the sterol and the monoglyceride can be fed into an extruder as solids and melted, then passed to another extruder where the sterol and monoglyceride are sheared, cooled and co-crystallized.

In these types of machines, ingredients may be cooked under high temperature and pressure, and thereafter extruded out of the machine. Extruders can be used to make products with little expansion (such as pasta), moderate expansion (shaped breakfast cereal, soy meat substitutes, breading substitutes, modified starches, pet foods (soft, moist and dry)), or a great deal of expansion (puffed snacks, puffed curls and balls, etc.).

The compositions described herein are not cooked. In some embodiments the extruder may be cold-jacketed, so as to cool the sterol-monoglyceride mixture.

In some embodiments that employ older extruders, the material may be extruded by means of a ram or a piston. In embodiments that employ more modern cooking extruders, one or more screws may be employed.

In embodiments described herein that combine melted sterol and monoglyceride under conditions of high shear, a modern screw-type extruder may be employed.

Variable pitch single screw extruders produce high product consistency by combining the ingredients to produce a homogeneous mixture, and pushing it out of the machine at a rate that is highly controllable. Twin screw extruders contain two screws that are either co-current (the screws rotate in the same direction) or are counter-current (the screws rotate In opposite directions). Twin screw extruders can handle material with a wide range of moisture content, and have greater control over the residence time and the amount of shear to which the material is exposed.

In embodiments described herein, either single- or twin screw extruders can be used, or a continuous processor extruder, such as, but not limited to, that manufactured by ReadCo (York, Pa., USA).

The ingredients may be fed into the extruder via a feeder, such as, but not limited to, a gravimetric or volumetric feeder. The type of feeder used will depend on its ability to handle warm liquid sterol and monoglyceride.

The melted sterol-monoglyceride mixture may be subjected to high shear. For example, a Wenger Twin Screw Model 52 extruder, commercially available from Wenger Manufacturing, Inc., Sabetha, Kans., can be used, with an internal configuration of feed screws, single and double mixers, and forward and reverse shear disks. In some embodiments, the extruder can be run at a rotational speed of 75 rpm, for example. Rotational speeds of 6 to 450 rpm can be used, and in some embodiments, rotational speeds of 25 to 150 rpm may be employed.

The head of the extruder may be cooled so that the sterol-monoglyceride mixture may be crystallized in the barrel of the extruder and pushed out through the end dies. In some embodiments, the sterol-monoglyceride mixture may be cooled to 70° C. or below.

After extrusion, the product may be ground to produce a free-flowing powder, that is, a powder that would pour and flow when elevated, for instance, at an incline of about 45 degrees or more.

The sterol-monoglyceride composition may be used in food product formulations to increase the sterols provided in a serving of the food product. For a composition of the invention having a particular percentage of sterol, one of skill in the art can easily calculate how much of the composition to use in a food product to produce a particular serving size with a particular level of sterol. For instance, to produce a beverage, e.g., a sports drink, with 0.5 grams of sterol per 250 gram serving, one may use 1.0 grams of a crystallized sterol-monoglyceride composition containing 50% sterol.

The Food and Drug Administration (“FDA”) of the United States has specifically defined enriched and fortified. According to the FDA, to say that a food, food product or food ingredient has been “enriched” with a substance means that the substance has been added so that the amount of the substance is approximately equal to that found in unprocessed foods, food products or food ingredients, while to say that a food, food product or food ingredient has been “fortified” with a substance means that the food, food product or food ingredient contains more of the substance than it did originally. However, as used herein, “fortified” and “enriched” are used interchangeably, and are intended to mean that the amount of phytosterol in the finished food product is higher than it would be had the food product not included the composition.

The desired serving may vary according to factors such as, for example, the age, sex, and weight of the person consuming them. The amount of sterols to be added to a food product can therefore be varied depending on estimates of the number of servings of the product that an individual can be expected to consume. A basic starting dosage, which can then be adjusted, can be about 0.4 grams to about 1.5 grams per serving.

Table 1, below, provides some guidance on representative amounts of the compositions to use to achieve different levels of sterols in a food product. Table 1 is exemplary only, and is not intended to limit the scope of the present invention.

TABLE 1
Amount of crystallized sterol-monoglyceride composition to use to achieve
various sterol contents in food products.

| Desired gm | | | | | |
|---|---|---|---|---|---|
| sterol/250 gm | Sterol Content of Composition | | | | |
| serving | 50% sterol | 60% sterol | 70% sterol | 80% sterol | 90% sterol |
| 0.4 gm/serving | 0.80 grams | 0.67 grams | 0.57 grams | 0.50 grams | 0.44 grams |
| 0.5 gm/serving | 1.00 grams | 0.83 grams | 0.71 grams | 0.63 grams | 0.56 grams |
| 0.8 gm/serving | 1.60 grams | 1.33 grams | 1.14 grams | 1.00 grams | 0.89 grams |
| 1.0 gm/serving | 2.00 grams | 1.67 grams | 1.43 grams | 1.25 grams | 1.11 grams |
| 1.2 gm/serving | 2.40 grams | 2.00 grams | 1.71 grams | 1.50 grams | 1.33 grams |
| 1.5 gm/serving | 3.00 grams | 2.50 grams | 2.14 grams | 1.88 grams | 1.67 grams |

By way of example, to produce a beverage enriched or fortified with added sterols, one can add to the beverage an amount of the composition sufficient to provide the desired level of sterols. The beverage may then be pasteurized, homogenized (such as by heating between about 1,000 pounds per square inch and about 25,000 pounds per square inch, or some other method of homogenization). The product can then be packaged.

The beverage can be any beverage that can be packaged and sold to consumers, such as bottled coffees, teas, juices, sports drinks, flavored drinks, milk, flavored milk, cocoas, coffees, and the like. By “juice” is meant not only juice from pressed fruit but also reconstituted fruit juices or synthetic juices made from flavored components. The liquid beverages in general can also include both fresh and reconstituted versions of the beverages.

To produce a dry beverage mix containing added sterols, one can add to the beverage mix an amount of the composition sufficient to provide the desired level of sterols. The beverage may then be pasteurized, homogenized, and packaged.

Dry beverage mixes to which the compositions can be added can include any powdered or crystallized beverage mix, such as powdered coffee, tea, iced tea mixes, powdered juice mixes, powdered sports drinks, powdered milk, and the like.

While this invention has been particularly shown and described with references to preferred embodiments thereof, it will be understood by those skilled in the art that various changes in form and details may be made therein without departing from the scope of the invention encompassed by the appended claims.

What is claimed is:

1. A method of making a crystallized monoglyceride-sterol mixture, the method comprising:
combining and melting a monoglyceride and a sterol, thus forming a mixture, wherein the sterol comprises between 50% and 90% of the mixture by weight; and
subjecting the mixture to high shear and cooling, thus producing the crystallized monoglyceride-sterol mixture.

2. The method of claim 1, further comprising grinding the crystallized monoglyceride-sterol mixture.

3. The method of claim 1, where the sterol is 75-85% by weight of the mixture.

4. The method of claim 1, where the sterol has a melting point greater than 120° C.

5. The method of claim 5, where the sterol has a melting point of between 140° C. and 145° C.

6. The method of claim 1, where the monoglyceride has a melting point greater than 25° C.

7. The method of claim 7, where the monoglyceride has a melting point of between 25° C. and 50° C.

8. The method of claim 1, wherein the mixture is cooled to 75° C. or below.

9. The method of claim 1, wherein high shear is conducted while cooling.

10. A method of making a food product fortified with sterols, the method comprising:
combining and melting a monoglyceride and a sterol, thus forming a mixture, where the sterol comprises between 50% and 90% of the mixture by weight;
subjecting the mixture to conditions of high shear and cooling, thus producing a crystallized sterol-monoglyceride composition; and
adding the crystallized sterol-monoglyceride composition to the food product.

11. The method of claim 10, further comprising grinding the crystallized monoglyceride-sterol mixture.

12. The method of claim 10, where the sterol is 75-85% by weight of the mixture.

13. The method of claim 10, wherein the food product is a liquid beverage or a dry beverage mix.

14. The method of claim 13, where the crystallized sterol-monoglyceride composition is added to the liquid beverage in an amount sufficient to provide between 0.4 grams to 1.5 grams of sterols per serving of beverage.

15. The method of claim 14, further comprising at least one of: pasteurizing the beverage, heat treating the beverage, homogenizing the beverage, and any combination thereof.

16. The method of claim 13, where the crystallized sterol-monoglyceride composition is added to the dry beverage mix in an amount sufficient to provide 0.4 grams to 1.5 grams of sterol per 250 grams of total beverage.

17. A crystallized monoglyceride-sterol composition, made by the method of claim 1.

18. The crystallized monoglyceride-sterol composition of claim 17, where the composition is a free-flowing dry powder.

19. A food product containing the composition of claim 17.

20. The food product of claim 19, where the food product is a liquid beverage or a dry beverage mix.
